(19) United States
(12) Patent Application Publication
(10) Pub. No.: US 2019/0171927 A1
(43) Pub. Date: Jun. 6, 2019

(54) LAYER-LEVEL QUANTIZATION IN NEURAL NETWORKS

(71) Applicant: Facebook, Inc., Menlo Park, CA (US)

(72) Inventors: Abdulkadir Utku Diril, Menlo Park, CA (US); Jong Soo Park, Mountain View, CA (US); Nadav Rotem, Santa Clara, CA (US); Mikhail Smelyanskiy, Burlingame, CA (US)

(21) Appl. No.: 15/833,985

(22) Filed: Dec. 6, 2017

(51) Int. Cl. G06N 3/04; G06N 5/04; G06N 3/08

(52) U.S. Cl. CPC G06N 3/04; G06N 3/08; G06N 5/046

(57) ABSTRACT

A method for performing layer-level quantization may include (1) performing an inference of an activation layer of a neural network, (2) storing a first limit value of the activation layer in a data storage system, (3) storing a second limit value of the activation layer in the data storage system, (4) determining a scaling factor based on the first and second limit values, and then (5) applying the scaling factor on a subsequent inference. Various other methods, systems, and devices are also disclosed.

### BACKGROUND

Artificial intelligence (AI) can enable computers to perform increasingly complicated tasks, particularly tasks related to cognitive functions associated with humans. Several approaches to AI are prevalent, including machine learning (ML) techniques. In ML, a computer may be programmed to parse data, learn from the data, and make predictions from real world inputs. With ML, a computer may be trained using data to perform a task, rather than explicitly programmed with a particular algorithm for performing the task. One ML approach, referred to as artificial neural networks, was inspired by the interconnections of neurons in a biological brain.

Neural networks are modeled after neurons, using connected layers similar to connected neurons. Each layer may receive an input, process the input, and pass an output to the next layer until the final layer produces a final output. Each layer may also assign a weight to its input. For example, if a task involves identifying a particular object in an image, these weights may correspond to a probability that the input matches the particular object. While calculations performed at these various layers may be computationally intensive, the advent of dedicated processing units have made neural networks more feasible. For example, the use of specialized processing hardware has given rise to significant advancements in deep learning, which is essentially a large neural network with many or “deep” layers.

However, even with the use of specialized processing hardware, such as accelerators that perform the computations of each layer, deep learning may tax existing computing systems. For example, convolutional neural networks (CNNs or ConvNets), which are deep, feed-forward neural networks, are often used for computer vision to analyze visual imagery. In a CNN, the layers often include filters and weights that are applied to inputs and output to the next layer. These filters and weights are typically determined through training. While specialized processing units known as inference accelerators may be used to perform inference, which is the process of using a trained neural network to make predictions from a new input, inference accelerators (as well as training accelerators) may exhibit various bottlenecks that slow down overall performance.

### SUMMARY

As will be described in greater detail below, the instant disclosure describes various systems and methods for performing layer-level quantization in neural networks. In one example, a computing system for performing such a task may include a data storage subsystem. The system may also include a hardware processing unit programmed to (1) perform an inference of an activation layer of a neural network, (2) store a first limit value of the activation layer in the data storage subsystem, (3) store a second limit value of the activation layer in the data storage subsystem, (4) determine a scaling factor based on the first and second limit values, and then (5) apply the scaling factor on a subsequent inference.

In some examples, the hardware processing unit may include an accelerator configured to maintain both the first and second limit values and the scaling factor in the data storage subsystem. In addition, the accelerator may be configured to associate the scaling factor with the activation layer. In some embodiments, the computing system may further include a processing element for determining a minimum value of the activation layer and a maximum value of the activation layer. The first limit value may correspond to the minimum value and the second limit value may correspond to the maximum value. In some examples, applying the scaling factor may reduce a bit width needed for at least one arithmetic operation within the neural network.

In some examples, the hardware processing unit may be further programmed to dynamically update the scaling factor. The hardware processing unit may also be programmed to update the scaling factor until the first limit value and the second limit value stabilize within a predetermined range.

Similarly, an accelerator may include a first data storage unit and a second data storage unit. The accelerator may also include a processing unit configured to (1) perform an inference of an activation layer of a neural network, (2) store a first limit value of the activation layer in the first data storage unit, (3) store a second limit value of the activation layer in the second data storage unit, (4) determine a scaling factor based on the first and second limit values, and (5) apply the scaling factor on a subsequent inference.

In some examples, the accelerator may further include a storage subsystem. In these examples, the processing unit may be configured to store the scaling factor in the storage subsystem in a manner that associates the scaling factor with the activation layer. The storage subsystem may also include the first and second data storage units. In one example, the accelerator may also include a processing element for determining both a minimum value of the activation layer and a maximum value of the activation layer. The first limit value may correspond to the minimum value and the second limit value may correspond to the maximum value. In some examples, applying the scaling factor may reduce a bit width needed for at least one arithmetic operation within the neural network.

In some examples, the processing unit may be further configured to dynamically update the scaling factor. The processing unit may also be configured to update the scaling factor until the first limit value and the second limit value stabilize within a predetermined range.

In addition, a corresponding method may include (1) performing an inference of an activation layer of a neural network, (2) storing a first limit value of the activation layer in a data storage system, (3) storing a second limit value of the activation layer in the data storage system, (4) determining a scaling factor based on the first and second limit values, and then (5) applying the scaling factor on a subsequent inference.

In some examples, the method may further include performing, before or after applying the scaling factor, an offset operation. The method may also include associating the scaling factor with the activation layer. In some examples, the method may further include determining a minimum value of the activation layer and a maximum value of the activation layer. The first limit value may correspond to the minimum value and the second limit value may correspond to the maximum value. In some examples, applying the scaling factor may reduce a bit width needed for at least one arithmetic operation within the neural network.

In some examples, the method may further include periodically updating the scaling factor. In addition, the method may include updating the scaling factor until the first limit value and the second limit value stabilize within a predetermined range.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for performing layer-level quantization within a neural network.

FIG. 2A is a block diagram of how nodes within an exemplary neural network may interconnect.

FIG. 2B is a block diagram of an exemplary individual node within a neural network.

FIG. 3 is a block diagram of an exemplary CNN.

FIG. 4 is a flow diagram of an exemplary method for layer-level quantization.

FIGS. 5A-5C and 6A-6C are block diagrams representing different exemplary types of floating point and integer numbers.

FIG. 7 is an exemplary accelerator configured for layer-level quantization.

FIG. 8 is a block diagram of an example computing system capable of implementing one or more of the embodiments described and/or illustrated herein.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to implementing layer-level quantization within neural networks by dynamically adjusting (e.g., for a particular dataset or group of datasets) quantization parameters for network layers. Embodiments of the instant disclosure may, while performing inference (and/or training) on a dataset, identify minimum and maximum values for activation layers (i.e., hidden or intermediate layers) of a neural network and then update scaling factors for the layers based on the identified values. For example, a layer-level quantization system (e.g., a system with quantization that is guided by data profiling) may include a hardware accelerator that tracks the minimum and maximum output values for activation layers and analyzes the output values to determine how (or whether) to adjust a quantization scaling factor. Embodiments of the instant disclosure may also be implemented via a variety of other hardware and/or software configurations.

By profiling datasets to guide layer-level quantization within a neural network, the systems and methods of the present disclosure may provide a number of features and advantages over traditional systems. For example, the quantization procedures discussed herein may adjust input scaling parameters over time to learn optimal layer-level quantization intervals for various datasets. In this way, embodiments of the instant disclosure may accelerate computation, reduce memory usage, reduce energy consumption and heat generation, and/or provide a number of other benefits in neural network processing.

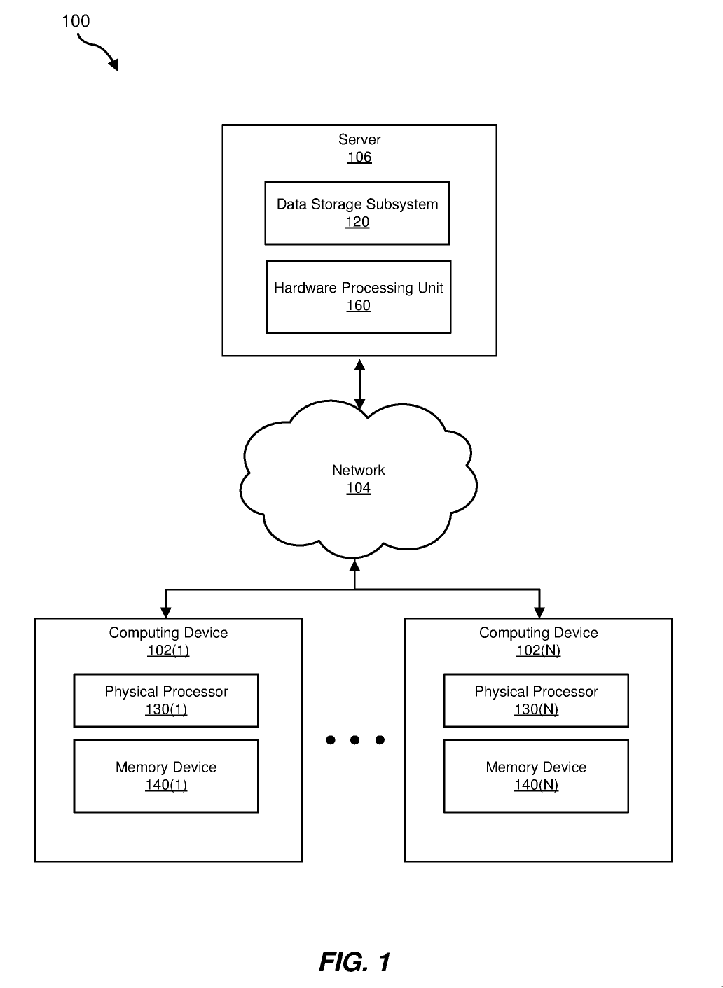

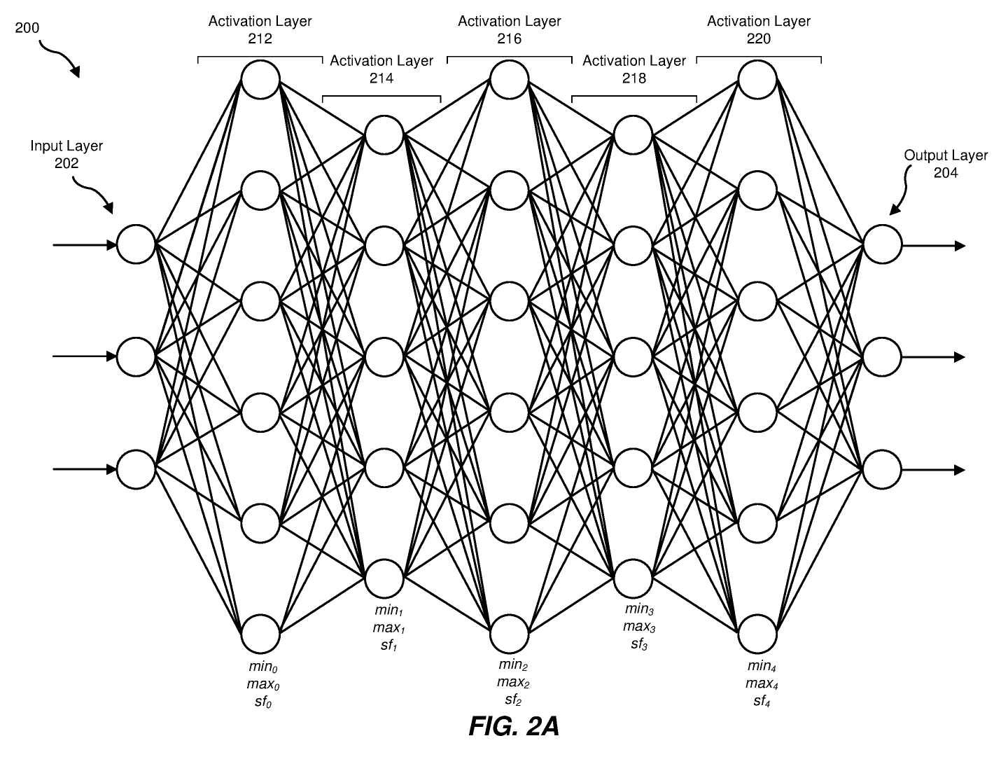

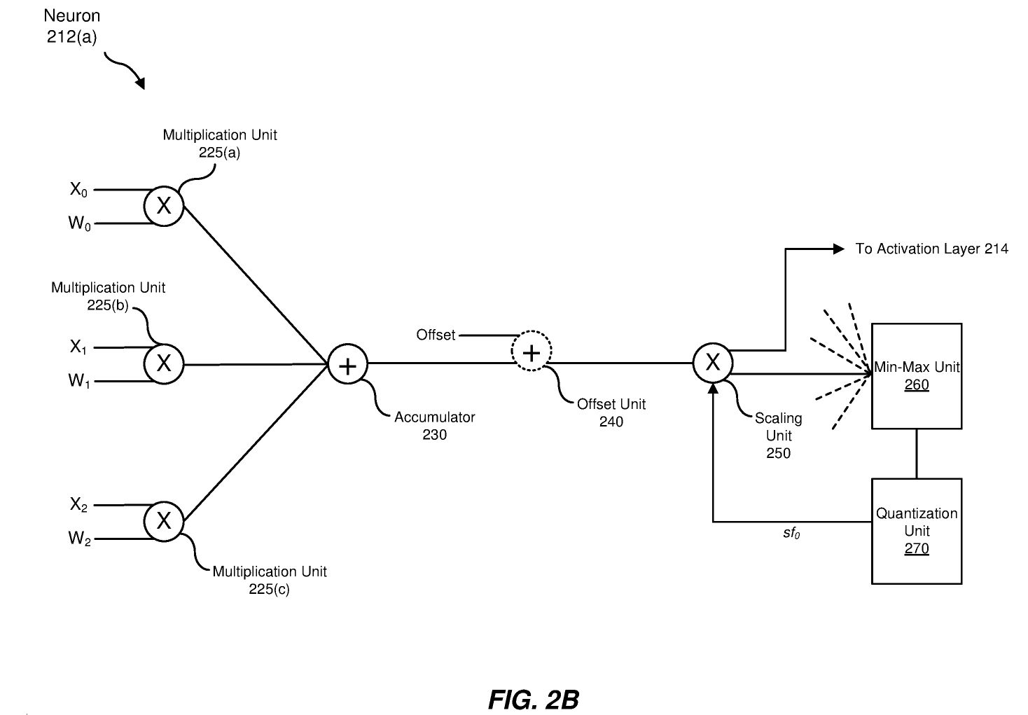

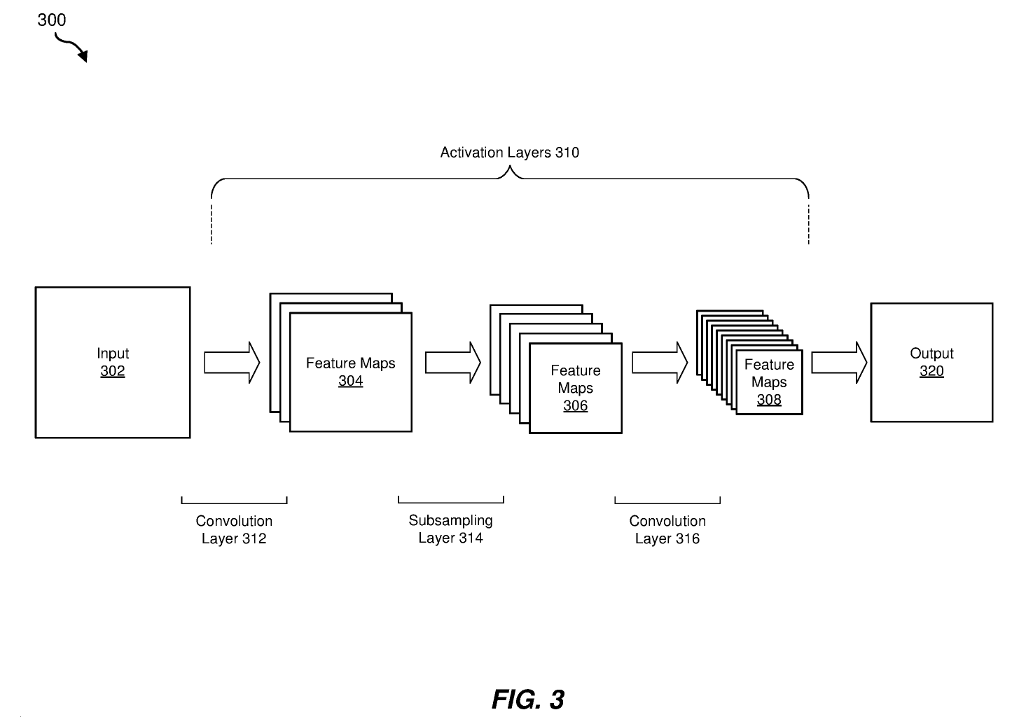

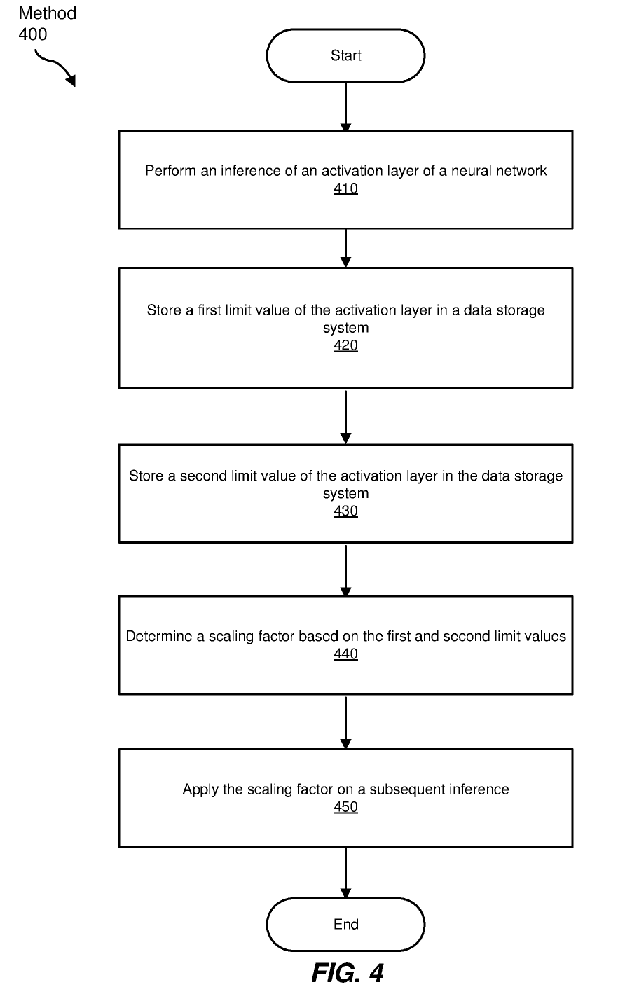

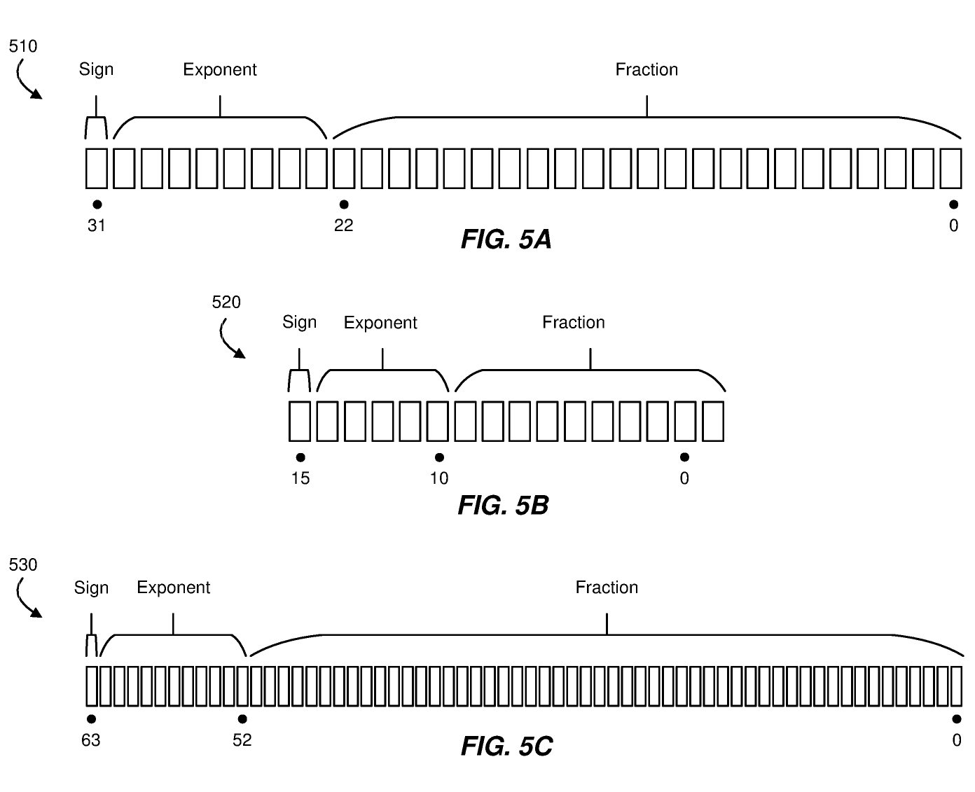

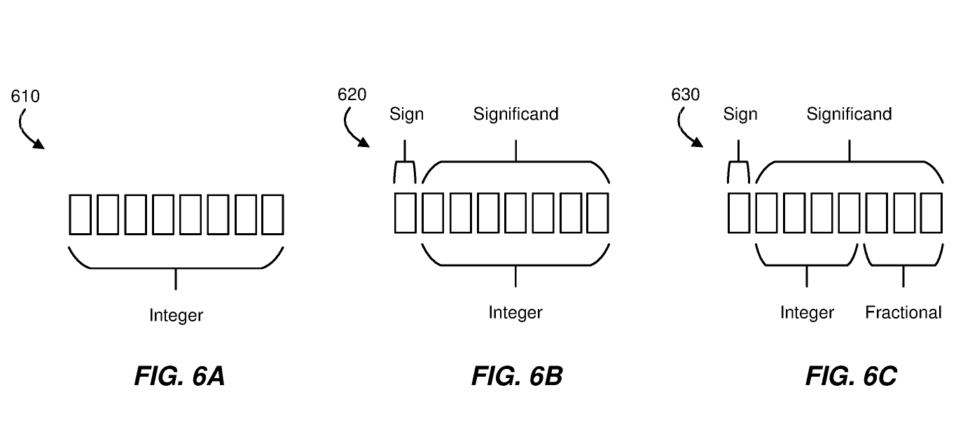

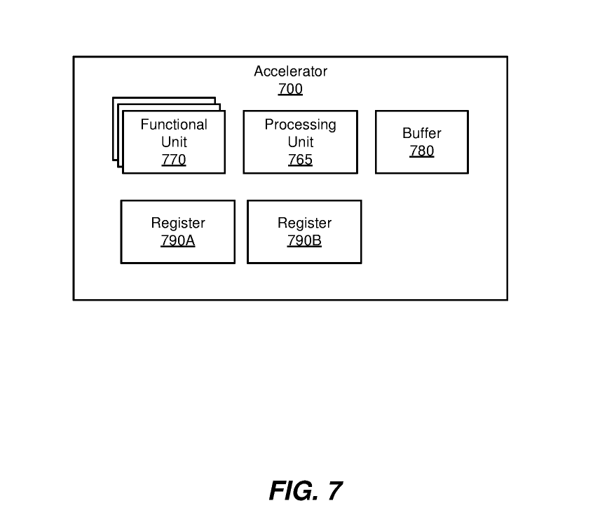

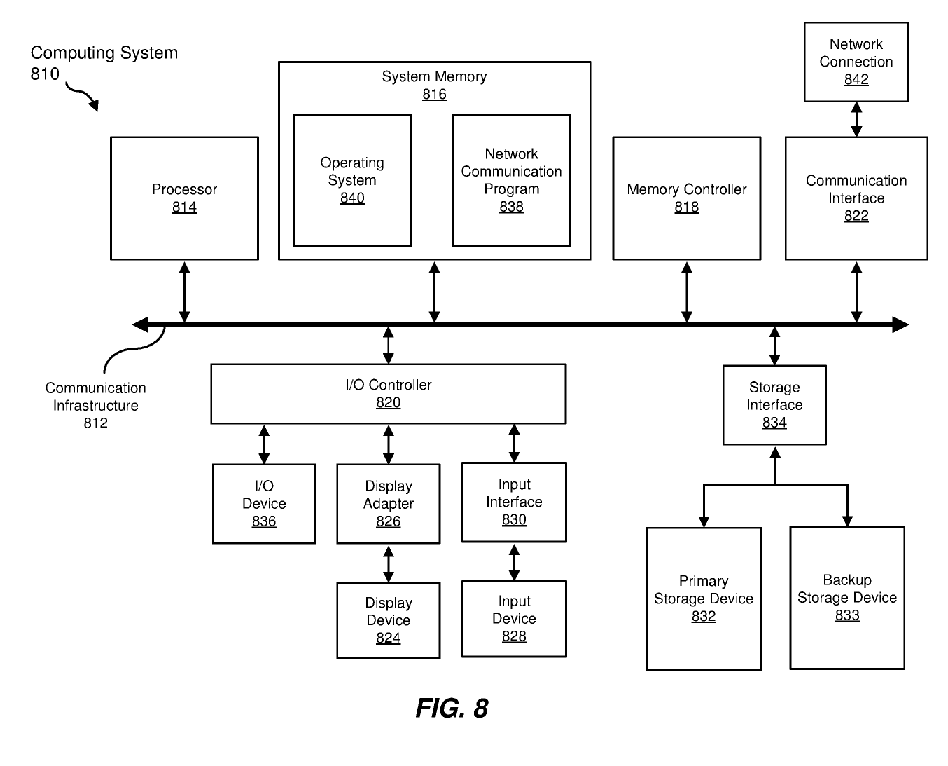

Turning to the figures, the following will provide, with reference to FIG. 1, detailed descriptions of an exemplary network environment. The following also provides, with reference to FIGS. 2A, 2B, and 3, a discussion of exemplary neural networks. The description of FIG. 4 covers a process for implementing layer-level quantization, and the discussion of FIGS. 5A-5C and 6A-6C discuss various options for reducing bit widths. The discussion of FIG. 7 presents an exemplary accelerator according to aspects of the present disclosure. The following also provides, with reference to FIG. 8, an example of a computing system with a CPU capable of implementing layer-level optimization.

FIG. 1 illustrates an exemplary network environment 100 (such as a social network environment) in which aspects of the present disclosure may be implemented. As shown, network environment 100 may include a plurality of computing devices 102(1)-(N), a network 104, and a server 106. Computing devices 102(1)-(N) may each represent a client device or a user device, such a desktop computer, laptop computer, tablet device, smartphone, or other computing device. Each of computing devices 102(1)-(N) may include a physical processor (e.g., physical processors 130(1)-(N)), which may represent a single processor or multiple processors, and a memory device (e.g., memory devices 140(1)-(N)), which may store instructions (e.g., software applications) or data.

Computing devices 102(1)-(N) may be communicatively coupled to server 106 through network 104. Network 104 may be any communication network, such as the Internet, a Wide Area Network (WAN), or a Local Area Network (WAN), and may include various types of communication protocols and physical connections.

As with computing devices 102(1)-(N), server 106 may represent a single server or multiple servers (e.g., a data center). Server 106 may host a social network or may be part of a system that hosts the social network. Server 106 may include a data storage subsystem 120, which may store instructions as described herein, and a hardware processing unit 160, which may include one or more processors and data storage units used for performing inference calculations for layers of a neural network. In some examples, the term “inference” generally refers to the process of causing a trained neural network to apply the learning gained from training to new data. Similarly, the term “training,” in some examples, generally refers to the process of using a training dataset to teach a neural network new inference (e.g., classification) capabilities.

The term “hardware processing unit” may, in some examples, refer to various types and forms of computer processors. In some examples, a hardware processing unit may include a central processing unit and/or a chipset corresponding to a central processing unit. Additionally or alternatively, a hardware processing unit may include a hardware accelerator (e.g., an AI accelerator, a video processing unit, a graphics processing unit, etc.) and may be implemented via one or more of a variety of technologies (e.g., an application-specific integrated circuit (ASIC), a field-programmable gate arrays (FPGA), etc.).

As noted, server 106 may host a social network, and in such embodiments, computing devices 102(1)-(N) may each represent an access point (e.g., an end-user device) for the social network. In some examples, a social network may refer to any type or form of service that enables users to connect through a network, such as the Internet. Social networks may enable users to share various types of content, including web pages or links, user-generated content such as photos, videos, posts, and/or to make comments or message each other through the social network.

In some embodiments, server 106 may access data (e.g., data provided by computing devices 102(1)-(N)) for analysis. For example, server 106 may perform various types of machine learning tasks on data. For instance, server 106 may use machine learning algorithms to rank feeds and search results, to identify spam, pornography, and/or other misleading content, to perform speech recognition (e.g., to automatically caption videos), to automate translation from one language to another, to enable computer vision (e.g., to identify objects in images, to turn panoramic photos into interactive 360 images, etc.), and/or to perform a variety of other tasks.

Embodiments of the instant disclosure may also be applied to various environments in addition to or instead of social networking environments. For example, the systems and methods disclosed herein may be used in video game development and game play (e.g., in reinforcement-learning techniques), to automate robotics tasks (e.g., grasping, stabilization, navigation, etc.), in medical research (e.g., genomics, cancer research, etc.), for autonomous vehicle navigation, and/or in any other suitable context.

In addition to being applied in a variety of technical fields, embodiments of the instant disclosure may also be applied to numerous different types of neural networks. For example, the systems and methods described herein may be implemented in any AI scheme that is designed to provide brain-like functionality via artificial neurons. In some examples (e.g., recurrent neural networks and/or feed-forward neural networks), these artificial neurons may be non-linear functions of a weighted sum of inputs that are arranged in layers, with the outputs of one layer becoming the inputs of a subsequent layer.

FIG. 2A is a block diagram of an exemplary feed-forward neural network 200. Neural network 200 may include an input layer 202, an output layer 204, and a series of five activation layers—activation layer 212, activation layer 214, activation layer 216, activation layer 218, and activation layer 220. While FIG. 2A provides an example with five activation layers, neural network 200 may include any other suitable number of activation layers (e.g., one activation layer, dozens of activation layers, thousands of activation layers, etc.).

In the example shown in FIG. 2A, data flows from input layer 202 thorough activation layers 212-220 to output layer 204 (i.e., from left to right). As shown, each value from the nodes of input layer 202 may be duplicated and sent to the nodes of activation layer 212. At activation layer 212, a set of weights (i.e., a filter) may be applied to the layer inputs, and each node may output a weighted sum that may be scaled (e.g., multiplied by a scaling factor sf₀) and propagated to activation layer 214. Neural network 200 may also store and/or update a first limit value (e.g., min₀), a second limit value (e.g., max₀), and a scaling factor (sf₀) based on the range of the outputs, as discussed in greater detail below. This process may be repeated at each activation layer in sequence to create outputs at layer 204.

FIG. 2B shows a block diagram of an individual node (i.e., an artificial neuron) within neural network 200. In the illustrated example, neuron 212(a) generally represents a node within activation layer 212. Neuron 212(a) may include multiplication units 225(a)-225(c) that receive data (x₀, x₁, and x₂) from each of the three nodes in input layer 202 and filter this data (e.g., by multiplying the data by weights w₀, w₁, and w₂). More specifically, (1) multiplication unit 225(a) may multiply data x₀, which may be received from the first node in input layer 202, by a weight w₀. (2), multiplication unit 225(b) may multiply data x₁, which may be received from the second node in input layer 202, by a weight w₁, and (3) multiplication unit 225(c) may multiply data x₂, which may be received from the third node in input layer 202, by a weight w₂.

Neuron 212(a) may also include one or more of a variety of additional logical units. For example, neuron 212(a) may include an accumulator 230 that sums weighted values received from multiplication units 225(a)-225(c) and outputs a weighted sum. In some embodiments, neuron 212 (a) may include an offset unit 240 that may shift an input by an offset value. Neuron 212(a) may also be implemented without an offset unit such that an output of accumulator 230 is provided directly to a scaling unit 250. Scaling unit 250 may multiply an input value by a scaling factor (e.g., sf₀) to quantize the input value to correspond to a bit width of operators within activation layer 214. The scaled output may also be provided to a min-max unit 260, which may identify a minimum output value (min₀) and a maximum output value (max₀) of activation layer 212. These minimum and maximum values may be provided to a quantization unit 270, which may use the values to calculate a scaling factor (sf₀) used by scaling unit 250. In some examples, offset unit 240, scaling unit 250, and/or quantization unit 270 may be configured to enable symmetric quantization (e.g., quantizing values to a range between −127 and 127) or asymmetric quantization (e.g., quantizing values to a range between 0 and 255).

Neuron 212(a) may also be implemented using any other suitable configuration. For example, neuron 212(a) may include additional or alternative logical units (e.g., a processor rather than a min-max unit to identify threshold values). The components in neuron 212(a) may also be arranged in any other suitable manner. For example, scaling unit 250 may be positioned to apply scaling before an offset is applied or to apply scaling at an input stage (e.g., before or after multiplication units 225(a)-225(c)).

While FIGS. 2A and 2B show one way to conceptualize a neural network, there are a variety of other ways to illustrate and conceptualize neural networks. For example, FIG. 3 shows a neural network 300 with activation layers 310 represented by sets of feature maps 304-308. In neural network 300, which may represent a CNN, an input 302 may undergo transformations for each of activation layers 310, which may be calculated by hardware such as processing unit 160, accelerator 700, and/or processor 814. For example, input 302 may undergo convolutions based on the filters and quantization parameters of convolution layer 312 to produce feature maps 304. Feature maps 304 may be the transformation of input 302 that results from drawing a filter (i.e., a sliding window) across a layer. Feature maps 304 may also undergo subsampling, based on the filters and parameters of subsampling layer 314, to produce feature maps 306, which may be reduced-size feature maps. In addition, feature maps 306 may undergo convolutions based on the filters and parameters of convolution layer 316 to produce feature maps 308. Finally, feature maps 308 may undergo further transformations, which may depend on a number of layers in neural network 300, to produce output 320. In one example, feature maps 308 may be transformed into probabilities of matching particular classifications, such that output 320 may be the most probable inference or classification for input 302.

As explain above in the discussion of FIG. 3, in a CNN each activation layer may be a set of nonlinear functions of spatially nearby subsets of outputs of a prior layer. Neural networks may also operate in a variety of other ways. For example, embodiments of the instant disclosure may be applied to a multi-layer perceptron (MLP), in which each activation layer is a set of nonlinear functions of the weighted sum of each output from a prior layer. Embodiments of the instant disclosure may also be applied to a recurrent neural network (RNN), in which each activation layer may be a collection of nonlinear functions of weighted sums of outputs and of a previous state. Embodiments of the instant disclosure may also be applied to any other suitable type or form of neural network.

FIG. 4 is a flow diagram of an exemplary computer-implemented method 400 for providing layer-level quantization in various types of neural networks. The steps shown in FIG. 4 may be performed by any suitable computer-executable code and/or computing system, including the system(s) illustrated in FIGS. 1, 7, and 8. In one example, each of the steps shown in FIG. 4 may represent an algorithm whose structure includes and/or is represented by multiple sub-steps, examples of which will be provided in greater detail below.

As illustrated in FIG. 4, at step 410 one or more of the systems described herein may perform an inference of an activation layer of a neural network. Accelerator 700 (which may, for example, be used as hardware processing unit 160) may include one or more functional units 770, a buffer 780, a register 790A, and a register 790B. Functional units 770 may include one or more logical units or other calculation hardware, such as matrix multipliers or general matrix-matrix multiplication (GEMM) units, used for performing calculations for a layer and/or other inference operations. Processing unit 765 may be a processor or other controller logic for coordinating operations of accelerator 700. Buffer 780 may be a memory device or other data storage unit for use during inference operations, for instance for storing weights, output data, etc. Registers 790A and 790B may be registers or other data storage units. In certain implementations, accelerator 700 may include a set of registers for each activation layer of the neural network. Alternatively, accelerator 700 may include a single set of registers shared by two or more layers. Register 790A, register 790B, and/or buffer 780 may be part of a data storage subsystem of accelerator 700. In various examples, the phrase “data storage subsystem” generally refers to any type or combination of one or more data storage units, including registers, caches, memory devices, etc.

Returning to FIG. 4, at step 420 one or more of the systems described herein may store a first limit value of the activation layer in a data storage system. For instance, processing unit 765 may store the first limit value in register 790A or within any other part of a data storage subsystem. The first limit value may correspond to a minimum value for the activation layer, such as an absolute sample minimum output (e.g., the lowest value of an activation layer, which may be identified by passing output values through a min-max unit) or an estimated minimum output value (e.g., an approximate minimum that discards outliers, a minimum within a predetermined standard deviation of values for a particular layer, etc.). One of functional units 770 may be a processing element (e.g., a min-max unit or any other suitable processing element) for determining or detecting the minimum value of the activation layer.

At step 430, one or more of the systems described herein may store a second limit value of the activation layer in the data storage system. For instance, accelerator 700 may store the second limit value in register 790B or in any other part of a data storage subsystem. This second limit value may correspond to a maximum value for the activation layer, such as an absolute maximum weight or filter value (e.g., the highest value of an activation layer, which may be identified by passing output values through a min-max unit) or an estimated maximum weight or filter value (e.g., an approximate maximum that discards outliers, a maximum within a predetermined standard deviation of values for a particular layer, etc.). One of functional units 770 may be a processing element for determining the maximum value of the activation layer. In certain implementations, a single functional unit 770 may determine the minimum value and the maximum value.

At step 440, one or more of the systems described herein may determine a scaling factor based on the first and second limit values. For example, accelerator 700 may use the minimum value from register 790A and the maximum value from register 790B to determine the scaling factor. The minimum and maximum values may span all or most of the dynamic values of the activation layer, and the scaling factor may be used to scale numbers between the minimum and maximum values linearly (e.g., in fixed quantization intervals) or non-linearly (e.g., in variable quantization intervals, such as logarithmic intervals) down to a smaller range, thereby quantizing a range of data to a range that can be represented by within a bit width of the arithmetic operators of a system or subsequent layer. The quantization scheme for determining the scaling factor may be designed to preserve as much accuracy as possible while reducing the bit width to a predetermined size or an optimal size for a dataset.

The scaling factor may be adjusted at any time during training or inference. For example, the scaling factor may be updated at fixed intervals (e.g., after a predetermined number of inferences has been performed). The scaling factor may also be adjusted relative to dataset processing (e.g., after each time a dataset or group of datasets is evaluated).

Accelerator 700 may store the scaling factor in buffer 780, in one of functional units 770, or in any other part of the data storage subsystem of accelerator 700. The scaling factor may be associated with the current activation layer in any suitable manner. For example, the scaling factor may be stored in a particular data storage unit associated with the current activation layer, may be stored as metadata for the current activation layer, etc.

At step 450, one or more of the systems described herein may apply the scaling factor on a subsequent inference. For example, at the start of the next inference (or any subsequent inference) for the activation layer, processing unit 765 may retrieve the associated scaling factor from buffer 780 and apply the scaling factor to the values of the activation layer. In certain implementations, rather than calculating and applying the scaling factor, accelerator 700 may retrieve the minimum and maximum values from registers 790A and 790B and determine the scaling factor at the start of inference. Applying the scaling factor in this manner may reduce the bit width of the arithmetic operations during inference of the activation layer.

While the examples illustrated herein show quantization being customized for each layer within a neural network, various other layer-level quantization schemes may be implemented. For example, layers may be grouped (e.g., in sets of 2 or more), and a single scaling factor may be selected for each group of layers. Furthermore, scaling optimization may not need to be performed for each layer in a neural network. For example, quantization scaling may be optimized for a single layer and/or a subset of layers within a neural network.

The systems and methods described herein may quantize any number represented by a particular bit width to a number represented by a narrower bit width. For example, accelerator 700 and/or processor 814 may quantize a single-precision floating point number (e.g., a 32-bit wide number with one sign bit, eight exponent bits, and 23 fraction bits, as represented by single-precision floating point number 510 in FIG. 5A) to a half-precision floating point number (e.g., a number represented by a sign bit, five exponent bits, and 10 fraction bits, such as half-precision floating-point number 520 in FIG. 5B), to an eight-bit unsigned integer (e.g., integer 610 in FIG. 6A), to an eight-bit signed integer (e.g., a number represented by a single sign bit and seven significand bits, such as integer 620 in FIG. 6B), an eight-bit dynamic fixed number (e.g., a number represented by a sign bit and a significand having four integer bits and three fractional bits, as represented by dynamic fixed number 630 in FIG. 6C), a four-bit number, a two bit number, etc. Additionally or alternatively, accelerator 700 and/or processor 814 may quantize a double-precision floating point number (e.g., a number represented by a sign bit, eleven exponent bits, and 52 fraction bits, as represented by double-precision floating point number 530 in FIG. 5C) to any number represented by less than 64 bits, such as a half-precision floating-point number, an eight-bit integer, etc.

Accelerator 700 and/or processor 814 may be configured to dynamically update the scaling factor by, for example, performing the steps of method 400 for every inference (or at any interval of inferences, as noted above) of an activation layer. In some examples, processing unit 765 may compare the current minimum and maximum values and replace one or both with new respective values if a difference between the respective old and new values is greater than a threshold. Accelerator 700 and/or processor 814 may be configured to perform updates of the scaling factor until the first limit value and the second limit value stabilize. For example, layer-level may observe that the minimum and maximum values have not changed outside a predetermined range over a predetermined amount of time and may therefore determine that the scaling factor no longer needs to be adjusted. This determination may, for example, be made on a per-layer basis or simultaneously for all layers within a neural network.

While some of the examples of the instant disclosure have been discussed in the context of the inference stage of neural network operation, the systems and methods of the instant disclosure may also be applied to either or both of the training and the inference stages of neural network operation. For example, a neural network may be trained using relatively high-precision floating-point operations (e.g., 32-bit floating point), which may optimize training accuracy, and during inference these floating-point numbers may be quantized into a smaller set of integers to increase calculation speed, to reduce resource usage, and/or to enable layer-level quantization in a hardware accelerator. Alternatively, both training and inference may be performed using some level of quantization (e.g., 16-bit quantization during training and 8-bit quantization during inference, 8-bit quantization during both training and inference, etc.).

Embodiments of the instant disclosure may also provide various advantages in neural networks implemented in both hardware accelerators and in neural networks running on general purpose processing units. Layer-level quantization may be advantageous in hardware accelerators by enabling optimized quantization that matches a bit width of operators within the hardware accelerators. In contrast, general purpose processing units may support high precision (e.g., 32- or 64-bit floating point) calculations, but reducing the bit width of operations may still provide energy and memory space savings. For example, energy expended when reading and writing to memory may be non-trivial, particularly for performing large numbers of operations on high-precision numbers, so reducing the size of reads to/from SRAM and DRAM may be advantageous.

FIG. 8 is a block diagram of an example computing system 810 capable of implementing one or more of the embodiments described and/or illustrated herein. For example, all or a portion of computing system 810 may perform and/or be a means for performing, either alone or in combination with other elements, one or more of the steps described herein (such as one or more of the steps illustrated in FIG. 4). All or a portion of computing system 810 may also perform and/or be a means for performing any other steps, methods, or processes described and/or illustrated herein.

Computing system 810 broadly represents any single or multi-processor computing device or system capable of executing computer-readable instructions. Examples of computing system 810 include, without limitation, workstations, laptops, client-side terminals, servers, distributed computing systems, handheld devices, or any other computing system or device. In its most basic configuration, computing system 810 may include at least one processor 814 and a system memory 816.

Processor 814 generally represents any type or form of physical processing unit (e.g., a hardware-implemented central processing unit) capable of processing data or interpreting and executing instructions. In certain embodiments, processor 814 may receive instructions from a software application or module. These instructions may cause processor 814 to perform the functions of one or more of the example embodiments described and/or illustrated herein.

System memory 816 generally represents any type or form of volatile or non-volatile storage device or medium capable of storing data and/or other computer-readable instructions. Examples of system memory 816 include, without limitation, Random Access Memory (RAM), Read Only Memory (ROM), flash memory, or any other suitable memory device. Although not required, in certain embodiments computing system 810 may include both a volatile memory unit (such as, for example, system memory 816) and a non-volatile storage device (such as, for example, primary storage device 832, as described in detail below).

In some examples, system memory 816 may store and/or load an operating system 840 for execution by processor 814. In one example, operating system 840 may include and/or represent software that manages computer hardware and software resources and/or provides common services to computer programs and/or applications on computing system 810. Examples of operating system 840 include, without limitation, LINUX, JUNOS, MICROSOFT WINDOWS, WINDOWS MOBILE, MAC OS, APPLE'S 10S, UNIX, GOOGLE CHROME OS, GOOGLE'S ANDROID, SOLARIS, variations of one or more of the same, and/or any other suitable operating system.

In certain embodiments, example computing system 810 may also include one or more components or elements in addition to processor 814 and system memory 816. For example, as illustrated in FIG. 8, computing system 810 may include a memory controller 818, an Input/Output (I/O) controller 820, and a communication interface 822. Communication infrastructure 812 generally represents any type or form of infrastructure capable of facilitating communication between one or more components of a computing device. Examples of communication infrastructure 812 include, without limitation, a communication bus (such as an Industry Standard Architecture (ISA), Peripheral Component Interconnect (PCI), PCI Express (PCIe), or similar bus) and a network.

Memory controller 818 generally represents any type or form of device capable of handling memory or data or controlling communication between one or more components of computing system 810. For example, in certain embodiments memory controller 818 may control communication between processor 814, system memory 816, and I/O controller 820 via communication infrastructure 812.

I/O controller 820 generally represents any type or form of module capable of coordinating and/or controlling the input and output functions of a computing device. For example, in certain embodiments I/O controller 820 may control or facilitate transfer of data between one or more elements of computing system 810, such as processor 814, system memory 816, communication interface 822, display adapter 826, input interface 830, and storage interface 834.

As illustrated in FIG. 8, computing system 810 may also include at least one display device 824 coupled to I/O controller 820 via a display adapter 826. Display device 824 generally represents any type or form of device capable of visually displaying information forwarded by display adapter 826. Similarly, display adapter 826 generally represents any type or form of device configured to forward graphics, text, and other data from communication infrastructure 812 (or from a frame buffer, as known in the art) for display on display device 824.

As illustrated in FIG. 8, example computing system 810 may also include at least one input device 828 coupled to I/O controller 820 via an input interface 830. Input device 828 generally represents any type or form of input device capable of providing input, either computer or human generated, to example computing system 810. Examples of input device 828 include, without limitation, a keyboard, a pointing device, a speech recognition device, variations or combinations of one or more of the same, and/or any other input device.

Additionally or alternatively, example computing system 810 may include additional I/O devices. For example, example computing system 810 may include I/O device 836. In this example, I/O device 836 may include and/or represent a user interface that facilitates human interaction with computing system 810. Examples of I/O device 836 include, without limitation, a computer mouse, a keyboard, a monitor, a printer, a modem, a camera, a scanner, a microphone, a touchscreen device, variations or combinations of one or more of the same, and/or any other I/O device.

Communication interface 822 broadly represents any type or form of communication device or adapter capable of facilitating communication between example computing system 810 and one or more additional devices. For example, in certain embodiments communication interface 822 may facilitate communication between computing system 810 and a private or public network including additional computing systems. Examples of communication interface 822 include, without limitation, a wired network interface (such as a network interface card), a wireless network interface (such as a wireless network interface card), a modem, and any other suitable interface. In at least one embodiment, communication interface 822 may provide a direct connection to a remote server via a direct link to a network, such as the Internet. Communication interface 822 may also indirectly provide such a connection through, for example, a local area network (such as an Ethernet network), a personal area network, a telephone or cable network, a cellular telephone connection, a satellite data connection, or any other suitable connection.

In certain embodiments, communication interface 822 may also represent a host adapter configured to facilitate communication between computing system 810 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 822 may also allow computing system 810 to engage in distributed or remote computing. For example, communication interface 822 may receive instructions from a remote device or send instructions to a remote device for execution.

In some examples, system memory 816 may store and/or load a network communication program 838 for execution by processor 814. In one example, network communication program 838 may include and/or represent software that enables computing system 810 to establish a network connection 842 with another computing system (not illustrated in FIG. 8) and/or communicate with the other computing system by way of communication interface 822. In this example, network communication program 838 may direct the flow of outgoing traffic that is sent to the other computing system via network connection 842. Additionally or alternatively, network communication program 838 may direct the processing of incoming traffic that is received from the other computing system via network connection 842 in connection with processor 814.

Although not illustrated in this way in FIG. 8, network communication program 838 may alternatively be stored and/or loaded in communication interface 822. For example, network communication program 838 may include and/or represent at least a portion of software and/or firmware that is executed by a processor and/or Application Specific Integrated Circuit (ASIC) incorporated in communication interface 822.

As illustrated in FIG. 8, example computing system 810 may also include a primary storage device 832 and a backup storage device 833 coupled to communication infrastructure 812 via a storage interface 834. Storage devices 832 and 833 generally represent any type or form of storage device or medium capable of storing data and/or other computer-readable instructions. For example, storage devices 832 and 833 may be a magnetic disk drive (e.g., a so-called hard drive), a solid state drive, a floppy disk drive, a magnetic tape drive, an optical disk drive, a flash drive, or the like. Storage interface 834 generally represents any type or form of interface or device for transferring data between storage devices 832 and 833 and other components of computing system 810.

In certain embodiments, storage devices 832 and 833 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 832 and 833 may also include other similar structures or devices for allowing computer software, data, or other computer-readable instructions to be loaded into computing system 810. For example, storage devices 832 and 833 may be configured to read and write software, data, or other computer-readable information. Storage devices 832 and 833 may also be a part of computing system 810 or may be a separate device accessed through other interface systems.

Many other devices or subsystems may be connected to computing system 810. Conversely, all of the components and devices illustrated in FIG. 8 need not be present to practice the embodiments described and/or illustrated herein. The devices and subsystems referenced above may also be interconnected in different ways from that shown in FIG. 8. Computing system 810 may also employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The term “computer-readable medium,” in some examples, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 810. All or a portion of the computer program stored on the computer-readable medium may then be stored in system memory 816 and/or various portions of storage devices 832 and 833. When executed by processor 814, a computer program loaded into computing system 810 may cause processor 814 to perform and/or be a means for performing the functions of one or more of the example embodiments described and/or illustrated herein. Additionally or alternatively, one or more of the example embodiments described and/or illustrated herein may be implemented in firmware and/or hardware. For example, computing system 810 may be configured as an Application Specific Integrated Circuit (ASIC) adapted to implement one or more of the example embodiments disclosed herein.

The present disclosure may provide hardware support, in an inference accelerator, that records the minimum and maximum values for each activation layer during inference for a neural network, such as a CNN. The minimum and maximum values may be stored in machine-specific registers accessible to firmware. After each invocation of the inference on a specific dataset, the firmware may read the minimum and maximum values for each layer from the registers, compute a new range, and update the quantization procedure with the new range. The firmware may machine learning techniques to find an ideal interval to optimize the CNN and further improve the efficacy of the machine learning accelerator. Thus, the bit width of the arithmetic operations for the layers may be reduced, which may speed up computation, reduce memory usage, and (over time) achieve an optimized quantization.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

The term “memory device,” in some examples, generally represents any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “physical processor,” in some examples, generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive data, such as weights and other values, to be transformed, transform the data, output a result of the transformation to store and be later accessed, use the result of the transformation to determine a scaling factor, and store the result of the transformation to apply quantization on a subsequent inference. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” in some examples, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computing system comprising:
a data storage subsystem; and
a hardware processing unit programmed to:
perform an inference of an activation layer of a neural network;
store a first limit value of the activation layer in the data storage subsystem;
store a second limit value of the activation layer in the data storage subsystem;
determine a scaling factor based on the first and second limit values; and
apply the scaling factor on a subsequent inference.

2. The computing system of claim 1, wherein the hardware processing unit comprises an accelerator configured to maintain the first and second limit values and the scaling factor in the data storage subsystem.

3. The computing system of claim 2, wherein the accelerator is further configured to associate the scaling factor with the activation layer.

4. The computing system of claim 1, further comprising a processing element for determining a minimum value of the activation layer and a maximum value of the activation layer, wherein the first limit value corresponds to the minimum value and the second limit value corresponds to the maximum value.

5. The computing system of claim 1, wherein applying the scaling factor reduces a bit width needed for at least one arithmetic operation within the neural network.

6. The computing system of claim 1, wherein the hardware processing unit is further configured to dynamically update the scaling factor.

7. The computing system of claim 6, wherein the hardware processing unit is further programmed to update the scaling factor until the first limit value and the second limit value stabilize within a predetermined range.

8. An accelerator comprising:
a first data storage unit;
a second data storage unit; and
a processing unit configured to:
perform an inference of an activation layer of a neural network;
store a first limit value of the activation layer in the first data storage unit;
store a second limit value of the activation layer in the second data storage unit;
determine a scaling factor based on the first and second limit values; and
apply the scaling factor on a subsequent inference.

9. The accelerator of claim 8, further comprising a storage subsystem, wherein:
the processing unit is configured to store the scaling factor in the storage subsystem in a manner that associates the scaling factor with the activation layer;
the storage subsystem comprises the first and second data storage units.

10. The accelerator of claim 8, further comprising a processing element for determining a minimum value of the activation layer and a maximum value of the activation layer, wherein the first limit value corresponds to the minimum value and the second limit value corresponds to the maximum value.

11. The accelerator of claim 8, wherein applying the scaling factor reduces a bit width needed for at least one arithmetic operation within the neural network.

12. The accelerator of claim 8, wherein the processing unit is configured to dynamically update the scaling factor.

13. The accelerator of claim 12, wherein the processing unit is configured to update the scaling factor until the first limit value and the second limit value stabilize within a predetermined range.

14. A method comprising:
performing an inference of an activation layer of a neural network;
storing a first limit value of the activation layer in a data storage system;
storing a second limit value of the activation layer in the data storage system;
determining a scaling factor based on the first and second limit values; and
applying the scaling factor on a subsequent inference.

15. The method of claim 14, further comprising performing, before or after applying the scaling factor, an offset operation.

16. The method of claim 15, further comprising associating the scaling factor with the activation layer.

17. The method of claim 14, further comprising determining a minimum value of the activation layer and a maximum value of the activation layer, wherein the first limit value corresponds to the minimum value and the second limit value corresponds to the maximum value.

18. The method of claim 14, wherein applying the scaling factor reduces a bit width needed for at least one arithmetic operation within the neural network.

19. The method of claim 14, further comprising periodically updating the scaling factor.

20. The method of claim 19, further comprising updating the scaling factor until the first limit value and the second limit value stabilize within a predetermined range.
